(19) United States
(12) Patent Application Publication
(10) Pub. No.: US 2026/0035596 A1
(43) Pub. Date: Feb. 5, 2026

(54) COMPOSITIONS FOR POLISHING SUBSTRATES

(71) Applicant: ENTEGRIS, INC., Billerica, MA (US)

(72) Inventors: Aditya Dilip Verma, San Jose, CA (US); Rajiv K. Singh, Newberry, FL (US); Pankaj K. Singh, Naperville, IL (US); Sunny De, Oviedo, FL (US)

(21) Appl. No.: 19/283,361

(22) Filed: Jul. 29, 2025

Related U.S. Application Data
(60) Provisional application No. 63/677,390, filed on Jul. 30, 2024.

(51) Int. Cl. C09G 1/02; B24B 37/04

(52) U.S. Cl. CPC C09G 1/02; B24B 37/044

(57) ABSTRACT

Compositions for polishing substrates are provided. A composition comprises at least one of a water soluble polymer, a first plurality of particles, a second plurality of particles, or any combination thereof. When the composition is contacted with a polycrystalline substrate and when the polycrystalline substrate is polished by the composition, the composition comprises a sufficient amount of the water soluble polymer, the first plurality of particles, and the second plurality of particles to result in a material removal rate of at least 0.5 μm; and/or an average surface roughness, Sₐ, of 50 Angstroms or less. The average surface roughness is measured by Atomic Force Microscopy (AFM) over a 10 μm×10 μm area. Related methods, among other things, are also provided.

### FIELD

The present disclosure relates to compositions for polishing substrates, and related systems and related methods, among others.

### BACKGROUND

Chemical mechanical planarization or chemical mechanical polishing (CMP) can be part of the manufacturing process for semiconductor devices. During CMP, material is removed from a wafer substrate via a polishing pad and a polishing slurry. CMP can optionally include one or more chemical reagents.

### SUMMARY

Some embodiments relate to a composition. In some embodiments, the composition comprises a water soluble polymer. In some embodiments, the composition comprises a first plurality of particles. In some embodiments, the composition comprises a second plurality of particles. In some embodiments, when the composition is contacted with a polycrystalline substrate and when the polycrystalline substrate is polished by the composition, the composition comprises a sufficient amount of the water soluble polymer, the first plurality of particles, and the second plurality of particles to result in A) a material removal rate of at least 0.5 μm; and/or B) an average surface roughness, Sₐ, of 50 Angstroms or less. In some embodiments, the average surface roughness is measured by Atomic Force Microscopy (AFM) over a 10 μm×10 μm area.

Some embodiments relate to a composition. In some embodiments, the composition comprises a first plurality of particles. In some embodiments, the composition comprises a second plurality of particles. In some embodiments, when the composition is contacted with a polycrystalline substrate and when the polycrystalline substrate is polished by the composition, the composition comprises a sufficient amount of the first plurality of particles and the second plurality of particles to result in A) a material removal rate of at least 0.5 μm; and/or B) an average surface roughness, Sₐ, of 50 Angstroms or less. In some embodiments, the average surface roughness is measured by Atomic Force Microscopy (AFM) over a 10 μm×10 μm area.

Some embodiments relate to a method. In some embodiments, the method comprises obtaining a polycrystalline substrate. In some embodiments, the method comprises obtaining a composition. In some embodiments, the composition comprises a water soluble polymer. In some embodiments, the composition comprises a first plurality of particles. In some embodiments, the composition comprises a second plurality of particles. In some embodiments, the method comprises polishing a polycrystalline substrate, while the composition is located between the polycrystalline substrate and a polishing pad, to obtain a polished substrate.

### DRAWINGS

FIG. 1 is a flowchart of a method for polishing a substrate, according to some embodiments.

### DETAILED DESCRIPTION

Some embodiments relate to a composition for polishing a substrate, such as, for example and without limitation, a polycrystalline substrate, among other non-polycrystalline substrates. The compositions are useful for improving surface roughness and material removal rates with less subsurface damage on hard materials, such as, for example and without limitation, hard polycrystalline materials comprising at least one of polysilicon carbide, polysilicon, the like, or any combination thereof, while also improving bonding to monocrystalline wafers for EPI deposition and/or fabrication of other MEMS devices, among other things. The compositions are stable and uniformly dispersed. In some embodiments, the compositions exhibit high removal rates and enhanced surface finishes when used for polishing polycrystalline substrates, without using hard metal or polymer plates. The compositions may be employed with polishing pads that are softer than conventional pads for polishing polycrystalline substrates.

The composition may comprise a water soluble polymer.

In some embodiments, the water soluble polymer comprises at least one of a clay, a polyolefin, an organic amine, a polyamide, a polyether, or any combination thereof. In some embodiments, the water soluble polymer comprises at least one of bentonite clay, 2-(2-ethoxyethoxy) ethanol, butyl carbitol, polyvinyl alcohols, polyvinyl pyrrolidones, polyethylene glycol (PEG), polyethylene oxide (PEO), poly-N-vinylpyrrolidone, polyacrylates, acrylate copolymers, polyethyleneimines, poly-N-vinyl acetamide, poly-N-methylvinyl acetamide, poly-2-ethyloxazoline, any copolymer thereof, or any combination thereof. In some embodiments, the water soluble polymer comprises a homopolymer or a copolymer prepared by polymerization of monomers including, for example and without limitation, at least one of vinyl monomers, vinyl carboxylates, N-vinyl compounds, cyclic ether vinyl compounds, mono vinyl ethers, or any combination thereof. In some embodiments, for example, the water soluble polymer comprises a homopolymer or a copolymer prepared by polymerization of monomers at least one of the styrene, chlorostyrene, α-methylstyrene, divinyl benzene, vinyl acetate, vinyl propionate, vinyl butyrate, vinyl octylate, vinyl caprate, vinyl laurate, vinyl myristate, vinyl stearate, vinyl adipate, vinyl(meth)acrylate, vinyl crotonate, vinyl sorbate, vinyl benzoate, vinyl cinnamate, acrylonitrile, limonene, cyclohexene 2-vinyl pyridine, 3-vinyl pyridine, 4-vinyl pyridine, N-vinyl pyrrolidone; N-vinyl acetamide, N-vinyl methyl acetamide, vinylfuran, 2-vinyl oxytetrapyran, methyl vinyl ether, ethyl vinyl ether, propyl vinyl ether, butyl vinyl ether, amyl vinyl ether, 2-ethylhexyl vinyl ether, octyl vinyl ether, nonyl vinyl ether, dodecyl vinyl ether, hexadecyl vinyl ether, octadecyl vinyl ether, butoxy ethylvinyl ether, cetyl vinyl ether, phenoxy ethylvinyl ether, allylvinyl ether, methallyl vinyl ether, glycidyl vinyl ether, 2-chloroethyl vinyl ether, cyclohexyl vinyl ether, ethylene glycol monovinyl ether, polyethylene glycol monovinyl ether, propylene glycol monovinyl ether, polypropylene glycolmonovinyl ether, 1,3-butylene glycol monovinyl ether, tetramethylene glycol monovinyl ether, hexamethylene glycol monovinyl ether, neopentyl glycol monovinyl ether, trimethylol propane monovinyl ether, glycerin monovinyl ether, pentaerythritol monovinyl ether, 1,4-cyclohexane dimethanol monovinyl ether, or any combination thereof.

The composition may comprise a first plurality of particles.

In some embodiments, the first plurality of particles comprises at least one of an alumina, a mixed phase alumina, aluminum oxides, aluminum nitrides, silicon dioxides, cerium oxides, zirconium oxides, titanium dioxides, silicon carbides, diamonds, iron oxides, or any combination thereof.

The composition may comprise a second plurality of particles.

In some embodiments, the second plurality of particles is different from the first plurality of particles. In some embodiments, the second plurality of particles comprises at least one of a diamond, aluminum oxides, aluminum nitrides, silicon dioxides, cerium oxides, zirconium oxides, titanium dioxides, silicon carbides, iron oxides, or any combination thereof.

In some embodiments, the composition comprises 0.01% to 5% by weight of the water soluble polymer based on a total weight of the composition, or any range or subrange between 0.01% and 5%. For example, in some embodiments, the composition may comprise between 0.01% to 4.5%, 0.01% to 4%, 0.01% to 3.5%, 0.01% to 3%, 0.01% to 2.5%, 0.01% to 2%, 0.01% to 1.5%, 0.01% to 1%, 0.01% to 0.5%, 0.01% to 0.4%, 0.01% to 0.3%, 0.01% to 0.2%, 0.01% to 0.1%, 0.5% to 5%, 1% to 5%, 1.5% to 5%, 2% to 5%, 2.5% to 5%, 3% to 5%, 3.5% to 5%, 4% to 5%, or 4.5% to 5% by weight of the water soluble polymer based on the total weight of the composition.

In some embodiments, the composition comprises 0.01% to 5% by weight of the first plurality of particles based on the total weight of the composition, or any range or subrange between 0.01% and 5%. For example, in some embodiments, the composition may comprise between 0.1% to 4.5%, 0.5% to 4%, 1% to 3.5%, 1.5% to 3%, or 2% to 2.5% by weight of the first plurality of particles based on the total weight of the composition. In some embodiments, the composition may comprise between 0.01% to 4.5%, 0.01% to 4%, 0.01% to 3.5%, 0.01% to 3%, 0.01% to 2.5%, 0.01% to 2%, 0.01% to 1.5%, 0.01% to 1%, 0.01% to 0.5%, 0.01% to 0.4%, 0.01% to 0.3%, 0.01% to 0.2%, 0.01% to 0.1%, 0.5% to 5%, 1% to 5%, 1.5% to 5%, 2% to 5%, 2.5% to 5%, 3% to 5%, 3.5% to 5%, 4% to 5%, or 4.5% to 5% by weight of the first plurality of particles based on the total weight of the composition.

In some embodiments, the composition comprises 0.01% to 5% by weight of the second plurality of particles based on the total weight of the composition, or any range or subrange between 0.01% and 5%. For example, in some embodiments, the composition may comprise between 0.1% to 4.5%, 0.5% to 4%, 1% to 3.5%, 1.5% to 3%, or 2% to 2.5% by weight of the second plurality of particles based on the total weight of the composition. In some embodiments, the composition may comprise between 0.01% to 4.5%, 0.01% to 4%, 0.01% to 3.5%, 0.01% to 3%, 0.01% to 2.5%, 0.01% to 2%, 0.01% to 1.5%, 0.01% to 1%, 0.01% to 0.5%, 0.01% to 0.4%, 0.01% to 0.3%, 0.01% to 0.2%, 0.01% to 0.1%, 0.5% to 5%, 1% to 5%, 1.5% to 5%, 2% to 5%, 2.5% to 5%, 3% to 5%, 3.5% to 5%, 4% to 5%, or 4.5% to 5% by weight of the second plurality of particles based on the total weight of the composition.

In some embodiments, the first plurality of particles has an average particle size of 50 nm to 10,000 nm, or any range or subrange between 50 nm and 10,000 nm. For example, in some embodiments, the first plurality of particles may have an average particle size of 100 nm to 9,000 nm, 200 nm to 8,000 nm, 300 nm to 7,000 nm, 400 nm to 6,000 nm, 500 nm to 5,000 nm, 600 nm to 4,000 nm, 700 nm to 3,000 nm, 800 nm to 2,000 nm, or 900 nm to 1,000 nm. In some embodiments, the first plurality of particles may have an average particle size of 50 nm to 9,000 nm, 50 nm to 8,000 nm, 50 nm to 7,000 nm, 50 nm to 6,000 nm, 50 nm to 5,000 nm, 50 nm to 4,000 nm, 50 nm to 3,000 nm, 50 nm to 2,000 nm, 50 nm to 1,000 nm, 50 nm to 900 nm, 50 nm to 800 nm, 50 nm to 700 nm, 50 nm to 600 nm, 50 nm to 500 nm, 50 nm to 400 nm, 50 nm to 300 nm, 50 nm to 200 nm, 50 nm to 100 nm, 100 nm to 10,000 nm, 200 nm to 10,000 nm, 300 nm to 10,000 nm, 400 nm to 10,000 nm, 500 nm to 10,000 nm, 600 nm to 10,000 nm, 700 nm to 10,000 nm, 800 nm to 10,000 nm, 900 nm to 10,000 nm, 1,000 nm to 10,000 nm, 2,000 nm to 10,000 nm, 3,000 nm to 10,000 nm, 4,000 nm to 10,000 nm, 5,000 nm to 10,000 nm, 6,000 nm to 10,000 nm, 7,000 nm to 10,000 nm, 8,000 nm to 10,000 nm, or 9,000 nm to 10,000 nm.

In some embodiments, the first plurality of particles has an average particle size of 10 nm to 5000 nm, or any range or subrange between 10 nm and 5000 nm. For example, in some embodiments, the first plurality of particles may have an average particle size of 20 nm to 4000 nm, 30 nm to 3000 nm, 40 nm to 2000 nm, 50 nm to 1000 nm, 60 nm to 900 nm, 70 nm to 800, 80 nm to 700 nm, 90 nm to 600 nm, 100 nm to 500 nm, or 200 nm to 400 nm. In some embodiments, the first plurality of particles may have an average particle size of 10 nm to 4000 nm, 10 nm to 3000 nm, 10 nm to 2000 nm, 10 nm to 1000 nm, 10 nm to 900 nm, 10 nm to 800, 10 nm to 700 nm, 10 nm to 600 nm, 10 nm to 500 nm, 10 nm to 400 nm, 10 nm to 300 nm, 10 nm to 200 nm, 10 nm to 100 nm, 10 nm to 90 nm, 10 nm to 80 nm, 10 nm to 70 nm, 10 nm to 60 nm, 10 nm to 50 nm, 10 nm to 40 nm, 10 nm to 30 nm, 10 nm to 20 nm, 20 nm to 5000 nm, 30 nm to 5000 nm, 40 nm to 5000 nm, 50 nm to 5000 nm, 60 nm to 5000 nm, 70 nm to 5000 nm, 80 nm to 5000 nm, 90 nm to 5000 nm, 100 nm to 5000 nm, 200 nm to 5000 nm, 300 nm to 5000 nm, 400 nm to 5000 nm, 500 nm to 5000 nm, 600 nm to 5000 nm, 700 nm to 5000 nm, 800 nm to 5000 nm, 900 nm to 5000 nm, 1000 nm to 5000 nm, 2000 nm to 5000 nm, 3000 nm to 5000 nm, or 4000 nm to 5000 nm.

In some embodiments, the first plurality of particles has an average particle size of 0.01 μm to 1 μm, or any range or subrange between 0.01 μm and 1 μm. For example, in some embodiments, the first plurality of particles may have an average particle size of 0.1 μm to 0.9 μm, 0.2 μm to 0.8 μm, 0.3 μm to 0.7 μm, or 0.4 μm to 0.6 μm. In some embodiments, the first plurality of particles may have an average particle size of 0.1 μm to 1 μm, 0.2 μm to 1 μm, 0.3 μm to 1 μm, 0.4 μm to 1 μm, 0.5 μm to 1 μm, 0.6 μm to 1 μm, 0.7 μm to 1 μm, 0.8 μm to 1 μm, or 0.9 μm to 1 μm. In some embodiments, the first plurality of particles may have an average particle size of 0.01 μm to 0.9 μm, 0.01 μm to 0.8 μm, 0.01 μm to 0.7 μm, 0.01 μm to 0.6 μm, 0.01 μm to 0.5 μm, 0.01 μm to 0.4 μm, 0.01 μm to 0.3 μm, 0.01 μm to 0.2 μm, or 0.01 μm to 0.1 μm.

In some embodiments, the second plurality of particles has an average particle size of 50 nm to 10,000 nm, or any range or subrange between 50 nm and 10,000 nm. For example, in some embodiments, the second plurality of particles may have an average particle size of 100 nm to 9,000 nm, 200 nm to 8,000 nm, 300 nm to 7,000 nm, 400 nm to 6,000 nm, 500 nm to 5,000 nm, 600 nm to 4,000 nm, 700 nm to 3,000 nm, 800 nm to 2,000 nm, or 900 nm to 1,000 nm. In some embodiments, the second plurality of particles may have an average particle size of 50 nm to 9,000 nm, 50 nm to 8,000 nm, 50 nm to 7,000 nm, 50 nm to 6,000 nm, 50 nm to 5,000 nm, 50 nm to 4,000 nm, 50 nm to 3,000 nm, 50 nm to 2,000 nm, 50 nm to 1,000 nm, 50 nm to 900 nm, 50 nm to 800 nm, 50 nm to 700 nm, 50 nm to 600 nm, 50 nm to 500 nm, 50 nm to 400 nm, 50 nm to 300 nm, 50 nm to 200 nm, 50 nm to 100 nm, 100 nm to 10,000 nm, 200 nm to 10,000 nm, 300 nm to 10,000 nm, 400 nm to 10,000 nm, 500 nm to 10,000 nm, 600 nm to 10,000 nm, 700 nm to 10,000 nm, 800 nm to 10,000 nm, 900 nm to 10,000 nm, 1,000 nm to 10,000 nm, 2,000 nm to 10,000 nm, 3,000 nm to 10,000 nm, 4,000 nm to 10,000 nm, 5,000 nm to 10,000 nm, 6,000 nm to 10,000 nm, 7,000 nm to 10,000 nm, 8,000 nm to 10,000 nm, or 9,000 nm to 10,000 nm.

In some embodiments, an average particle size of the second plurality of particles is different from an average particle size of the first plurality of particles. In some embodiments, the second plurality of particles has an average particle size of 10 nm to 5000 nm, or any range or subrange between 10 nm and 5000 nm. For example, in some embodiments, the second plurality of particles may have an average particle size of 20 nm to 4000 nm, 30 nm to 3000 nm, 40 nm to 2000 nm, 50 nm to 1000 nm, 60 nm to 900 nm, 70 nm to 800, 80 nm to 700 nm, 90 nm to 600 nm, 100 nm to 500 nm, or 200 nm to 400 nm. In some embodiments, the second plurality of particles may have an average particle size between 10 nm to 4000 nm, 10 nm to 3000 nm, 10 nm to 2000 nm, 10 nm to 1000 nm, 10 nm to 900 nm, 10 nm to 800, 10 nm to 700 nm, 10 nm to 600 nm, 10 nm to 500 nm, 10 nm to 400 nm, 10 nm to 300 nm, 10 nm to 200 nm, 10 nm to 100 nm, 10 nm to 90 nm, 10 nm to 80 nm, 10 nm to 70 nm, 10 nm to 60 nm, 10 nm to 50 nm, 10 nm to 40 nm, 10 nm to 30 nm, 10 nm to 20 nm, 20 nm to 5000 nm, 30 nm to 5000 nm, 40 nm to 5000 nm, 50 nm to 5000 nm, 60 nm to 5000 nm, 70 nm to 5000 nm, 80 nm to 5000 nm, 90 nm to 5000 nm, 100 nm to 5000 nm, 200 nm to 5000 nm, 300 nm to 5000 nm, 400 nm to 5000 nm, 500 nm to 5000 nm, 600 nm to 5000 nm, 700 nm to 5000 nm, 800 nm to 5000 nm, 900 nm to 5000 nm, 1000 nm to 5000 nm, 2000 nm to 5000 nm, 3000 nm to 5000 nm, or 4000 nm to 5000 nm.

In some embodiments, the second plurality of particles has an average particle size of 0.01 μm to 5 μm, or any range or subrange between 0.01 μm and 5 μm. For example, in some embodiments, the second plurality of particles may have an average particle size of 0.1 μm to 4.5 μm, 0.5 μm to 4 μm, 1 μm to 3.5 μm, 1.5 μm to 3 μm, or 2 μm to 2.5 μm. In some embodiments, the second plurality of particles may have an average particle size of 0.01 μm to 4.5 μm, 0.01 μm to 4 μm, 0.01 μm to 3.5 μm, 0.01 μm to 3 μm, 0.01 μm to 2.5 μm, 0.01 μm to 2 μm, 0.01 μm to 1.5 μm, 0.01 μm to 1 μm, 0.01 μm to 0.5 μm, or 0.01 μm to 0.1 μm.

In some embodiments, the first plurality of particles has an isoelectric point of greater than 7. In some embodiments, the first plurality of particles has an isoelectric point of 8 to 15, or any range or subrange between 8 and 15. For example, in some embodiments, the first plurality of particles has an isoelectric point of 9 to 14, 10 to 13, or 11 to 12. In some embodiments, the first plurality of particles has an isoelectric point of 8 to 14, 8 to 13, 8 to 12, 8 to 11, 8 to 10, 8 to 9, 9 to 15, 10 to 15, 11 to 15, 12 to 15, 13 to 15, or 14 to 15.

In some embodiments, the second plurality of particles has an isoelectric point that is different from an isoelectric point of the first plurality of particles. In some embodiments, the second plurality of particles has an isoelectric point of 7 or less. In some embodiments, the second plurality of particles has an isoelectric point of 0.1 to 7, or any range or subrange between 0.1 and 7. For example, in some embodiments, the second plurality of particles has an isoelectric point of 0.5 to 6, 1 to 5, or 2 to 4. In some embodiments, the second plurality of particles has an isoelectric point of 0.1 to 6, 0.1 to 5, 0.1 to 4, 0.1 to 3, 0.1 to 2, 0.1 to 1, 0.5 to 7, 1 to 7, 2 to 7, 3 to 7, 4 to 7, 5 to 7, or 6 to 7.

In some embodiments, the first plurality of particles has a substantially non-spherical shape. For example, in some embodiments, the first plurality of particles may comprise substantially non-spherical shapes such as flakes, sheets, tubes, cubes, rods, prisms, disks, capsules, shells, ellipsoidal, bipyramidal, pyramidal, or any combination thereof.

In some embodiments, the second plurality of particles has a shape that is different from a shape of the first plurality of particles. In some embodiments, the second plurality of particles may comprise substantially non-spherical shapes such as flakes, sheets, tubes, cubes, rods, prisms, disks, capsules, shells, ellipsoidal, bipyramidal, pyramidal, or any combination thereof.

In some embodiments, the first plurality of particles has a dimension and/or a shape sufficient for the second plurality of particles to associate with the first plurality of particles. For example, in some embodiments, when the composition is used for polishing, the first plurality of particles and the second plurality of particles associate with each other to form another particle. For example, in some embodiments, when the second plurality of particles comprises a diamond and the first plurality of particles comprises an alumina, the diamond is attracted to and/or associates with the alumina surface. In some embodiments, the first plurality of particles and the second plurality of particles, when used separately and without each other, results in a higher roughness than when the first plurality of particles and the second plurality of particles are used together. In some embodiments, the water soluble polymer is useful for increasing surface contact of the composition with the substrate. In some embodiments, the water soluble polymer is useful for stabilizing the composition.

In some embodiments, the first plurality of particles is dimensioned so as to have an aspect ratio of 2:1 to 10:1. For example, in some embodiments, the first plurality of particles may be dimensioned so as to have an aspect ratio between 3:1 to 9:1, 4:1 to 8:1, or 5:1 to 7:1. In some embodiments, the first plurality of particles may be dimensioned so as to have an aspect ratio between 2:1 to 9:1, 2:1 to 8:1, 2:1 to 7:1, 2:1 to 6:1. 2:1 to 5:1, 2:1 to 4:1, 2:1 to 3:1, 3:1 to 10:1. 4:1 to 10:1, 5:1 to 10:1, 6:1 to 10:1, 7:1 to 10:1, 8:1 to 10:1, or 9:1 to 10:1.

In some embodiments, when the composition is contacted with a substrate and when the substrate is polished by the composition, the composition comprises a sufficient amount of at least one of the water soluble polymer, the first plurality of particles, the second plurality of particles, or any combination thereof, to result in a material removal rate of at least 0.5 μm and/or an average surface roughness, Sₐ, of 50 Angstroms or less. In some embodiments, the substrate comprises a polycrystalline substrate. In some embodiments, a substrate is polycrystalline when a grain size is at least 1 nm, up to a size in the range of millimeters. Depending on whether the substrate is single crystal, amorphous, or polycrystalline, any one or more of AFM, SEM, or an optical microscope may be used to determine whether the substrate is single crystal, amorphous, or polycrystalline. In some embodiments, the average surface roughness is measured by Atomic Force Microscopy (AFM) over a 10 μm×10 μm area.

In some embodiments, the material removal rate of the composition is 0.5 μm per hour to 25 μm per hour, or any range or subrange between 0.5 μm per hour to 25 μm per hour. For example, in some embodiments, the material removal rate of the composition may range between 0.5 μm per hour to 24 μm per hour, 0.5 μm per hour to 23 μm per hour, 0.5 μm per hour to 23 μm per hour, 0.5 μm per hour to 21 μm per hour, 0.5 μm per hour to 20 μm per hour, 0.5 μm per hour to 19 μm per hour, 0.5 μm per hour to 18 μm per hour, 0.5 μm per hour to 17 μm per hour, 0.5 μm per hour to 16 μm per hour, 0.5 μm per hour to 15 μm per hour, 0.5 μm per hour to 14 μm per hour, 0.5 μm per hour to 13 μm per hour, 0.5 μm per hour to 12 μm per hour, 0.5 μm per hour to 11 μm per hour, 0.5 μm per hour to 10 μm per hour, 0.5 μm per hour to 9 μm per hour, 0.5 μm per hour to 8 μm per hour, 0.5 μm per hour to 7 μm per hour, 0.5 μm per hour to 6 μm per hour, 0.5 μm per hour to 5 μm per hour, 0.5 μm per hour to 4 μm per hour, 0.5 μm per hour to 3 μm per hour, 0.5 μm per hour to 2 μm per hour, 0.5 μm per hour to 1 μm per hour, 1 μm per hour to 25 μm per hour, 2 μm per hour to 25 μm per hour, 3 μm per hour to 25 μm per hour, 4 μm per hour to 25 μm per hour, 5 μm per hour to 25 μm per hour, 6 μm per hour to 25 μm per hour, 7 μm per hour to 25 μm per hour, 8 μm per hour to 25 μm per hour, 9 μm per hour to 25 μm per hour, 10 μm per hour to 25 μm per hour, 11 μm per hour to 25 μm per hour, 12 μm per hour to 25 μm per hour, 13 μm per hour to 25 μm per hour, 14 μm per hour to 25 μm per hour, 15 μm per hour to 25 μm per hour, 16 μm per hour to 25 μm per hour, 17 μm per hour to 25 μm per hour, 18 μm per hour to 25 μm per hour, 19 μm per hour to 25 μm per hour, 20 μm per hour to 25 μm per hour, 21 μm per hour to 25 μm per hour, 22 μm per hour to 25 μm per hour, 23 μm per hour to 25 μm per hour, or 24 μm per hour to 25 μm per hour.

In some embodiments, the average surface roughness, Sₐ, (or roughness average, Rₐ) of the polycrystalline substrate is 1 Angstrom to 50 Angstroms, or any range or subrange between 1 Angstrom and 50 Angstroms. For example, in some embodiments, the average surface roughness, Sₐ, of the polycrystalline substrate is 1 Angstrom to 45 Angstroms, 1 Angstrom to 40 Angstroms, 1 Angstrom to 35 Angstroms, 1 Angstrom to 30 Angstroms, 1 Angstrom to 25 Angstroms, 1 Angstrom to 20 Angstroms, 1 Angstrom to 18 Angstroms, 1 Angstrom to 16 Angstroms, 1 Angstrom to 15 Angstroms, 1 Angstrom to 14 Angstroms, 1 Angstrom to 12 Angstroms, 1 Angstrom to 10 Angstroms, 1 Angstrom to 9 Angstroms, 1 Angstrom to 8 Angstroms, 1 Angstrom to 7 Angstroms, 1 Angstrom to 6 Angstroms, 1 Angstrom to 5 Angstroms, 1 Angstrom to 4 Angstroms, 1 Angstrom to 3 Angstroms, 1 Angstrom to 2 Angstroms, 2 Angstroms to 10 Angstroms, 3 Angstroms to 10 Angstroms, 4 Angstroms to 10 Angstroms, 5 Angstroms to 10 Angstroms, 6 Angstroms to 10 Angstroms, 7 Angstroms to 10 Angstroms, 8 Angstroms to 10 Angstroms, or 9 Angstroms to 10 Angstroms. In some embodiments, the average surface roughness, Sₐ, of the polycrystalline substrate is 5 Angstroms to 50 Angstroms, 10 Angstroms to 50 Angstroms, 15 Angstroms to 50 Angstroms, 20 Angstroms to 50 Angstroms, 25 Angstroms to 50 Angstroms, 30 Angstroms to 50 Angstroms, 35 Angstroms to 50 Angstroms, 40 Angstroms to 50 Angstroms, or 45 Angstroms to 50 Angstroms. In some embodiments, the average surface roughness refers to the root mean square (RMS) roughness.

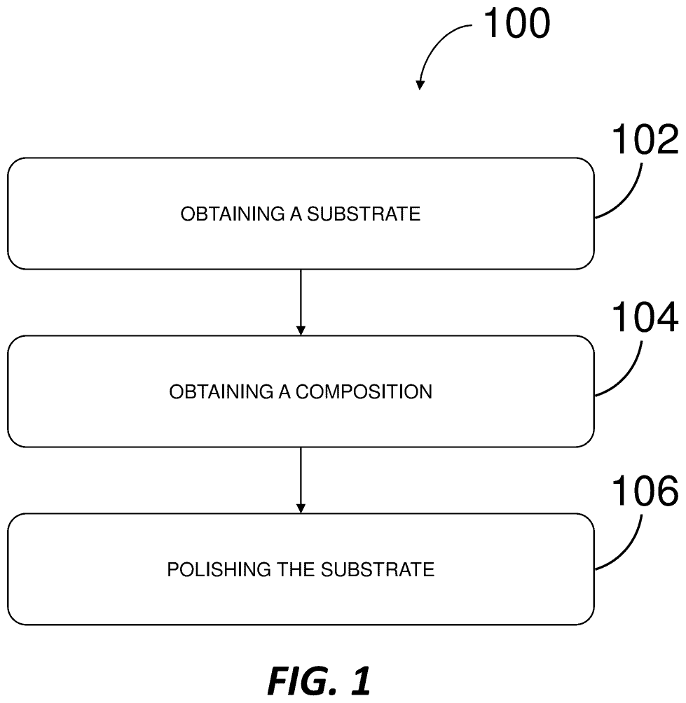

FIG. 1 is a schematic diagram of a flowchart of a method 100, according to some embodiments. As shown in FIG. 1, in some embodiments, the method 100 comprises one or more of the following steps: obtaining 102 a substrate; obtaining 104 a composition; and polishing 106 a polycrystalline substrate, while the composition is located between the polycrystalline substrate and a polishing pad, to obtain a polished substrate.

At step 102, in some embodiments, the method comprises obtaining 102 a substrate.

In some embodiments, the substrate comprises a polycrystalline substrate. In some embodiments, the substrate comprises at least one of a polycrystalline silicon, a polycrystalline gallium arsenide, a polycrystalline silicon carbide, a polycrystalline tin oxide, a polycrystalline graphite, a polycrystalline tantalum nitride, a polycrystalline ceramic, or any combination thereof.

At step 104, in some embodiments, the method comprises obtaining 104 a composition.

In some embodiments, the composition comprises any one or more of the compositions disclosed herein. For example, in some embodiments, the composition comprises at least one of a water soluble polymer, a first plurality of particles, a second plurality of particles, or any combination thereof.

At step 106, in some embodiments, the method comprises polishing the substrate, while the composition is located between the substrate and a polishing pad, to obtain a polished substrate.

The polishing pad may comprise a soft polishing pad. In some embodiments, the polishing pad may have a Shore A hardness in a range of 35 to 98, or any range or subrange between 35 and 98. In some embodiments, for example, the polishing pad may have a Shore A hardness in a range of 40 to 95, 45 to 90, 50 to 85, 55 to 80, 60 to 75, or 65 to 70. In some embodiments, the polishing pad may have a Shore A hardness in a range of 40 to 98, 45 to 98, 50 to 98, 55 to 98, 60 to 98, 65 to 98, 70 to 98, 75 to 98, 80 to 98, 85 to 98, 90 to 98, or 95 to 98. In some embodiments, the polishing pad may have a Shore A hardness in a range of 35 to 95, 35 to 90, 35 to 85, 35 to 80, 35 to 75, 35 to 70, 35 to 65, 35 to 60, 35 to 55, 35 to 50, 35 to 45, or 35 to 40.

In some embodiments, the polishing pad may have a Shore D hardness in a range of 30 to 70, or any range or subrange between 30 and 70. In some embodiments, for example, the polishing pad may have a Shore D hardness in a range of 35 to 65, 40 to 60, or 45 to 55. In some embodiments, for example, the polishing pad may have a Shore D hardness in a range of 35 to 70, 40 to 70, 45 to 70, 50 to 70, 55 to 70, 60 to 70, or 65 to 70. In some embodiments, for example, the polishing pad may have a Shore D hardness in a range of 30 to 65, 30 to 60, 35 to 55, 30 to 50, 35 to 45, or 35 to 40.

In some embodiments, the polishing pad does not comprise a metal plate and/or a polymer plate. In some embodiments, the polishing pad does not comprise a diamond grid. In some embodiments, the polishing pad comprises a polymeric material.

In some embodiments, the polishing comprises removing material at a rate of 0.5 μm per hour to 25 μm per hour. For example, in some embodiments, the material removal rate of the composition may range between 0.5 μm per hour to 24 μm per hour, 0.5 μm per hour to 23 μm per hour, 0.5 μm per hour to 23 μm per hour, 0.5 μm per hour to 21 μm per hour, 0.5 μm per hour to 20 μm per hour, 0.5 μm per hour to 19 μm per hour, 0.5 μm per hour to 18 μm per hour, 0.5 μm per hour to 17 μm per hour, 0.5 μm per hour to 16 μm per hour, 0.5 μm per hour to 15 μm per hour, 0.5 μm per hour to 14 μm per hour, 0.5 μm per hour to 13 μm per hour, 0.5 μm per hour to 12 μm per hour, 0.5 μm per hour to 11 μm per hour, 0.5 μm per hour to 10 μm per hour, 0.5 μm per hour to 9 μm per hour, 0.5 μm per hour to 8 μm per hour, 0.5 μm per hour to 7 μm per hour, 0.5 μm per hour to 6 μm per hour, 0.5 μm per hour to 5 μm per hour, 0.5 μm per hour to 4 μm per hour, 0.5 μm per hour to 3 μm per hour, 0.5 μm per hour to 2 μm per hour, 0.5 μm per hour to 1 μm per hour, 1 μm per hour to 25 μm per hour, 2 μm per hour to 25 μm per hour, 3 μm per hour to 25 μm per hour, 4 μm per hour to 25 μm per hour, 5 μm per hour to 25 μm per hour, 6 μm per hour to 25 μm per hour, 7 μm per hour to 25 μm per hour, 8 μm per hour to 25 μm per hour, 9 μm per hour to 25 μm per hour, 10 μm per hour to 25 μm per hour, 11 μm per hour to 25 μm per hour, 12 μm per hour to 25 μm per hour, 13 μm per hour to 25 μm per hour, 14 μm per hour to 25 μm per hour, 15 μm per hour to 25 μm per hour, 16 μm per hour to 25 μm per hour, 17 μm per hour to 25 μm per hour, 18 μm per hour to 25 μm per hour, 19 μm per hour to 25 μm per hour, 20 μm per hour to 25 μm per hour, 21 μm per hour to 25 μm per hour, 22 μm per hour to 25 μm per hour, 23 μm per hour to 25 μm per hour, or 24 μm per hour to 25 μm per hour.

In some embodiments, the polishing is sufficient to obtain a polished substrate having an average surface roughness, Sₐ, of 50 Angstroms or less as measured by Atomic Force Microscopy (AFM) over a 10 μm×10 μm area. For example, in some embodiments, average surface roughness may be of 45 Angstroms or less as measured by Atomic Force Microscopy (AFM) over a 10 μm×10 μm area, of 40 Angstroms or less as measured by Atomic Force Microscopy (AFM) over a 10 μm×10 μm area, of 35 Angstroms or less as measured by Atomic Force Microscopy (AFM) over a 10 μm×10 μm area, of 30 Angstroms or less as measured by Atomic Force Microscopy (AFM) over a 10 μm×10 μm area, of 25 Angstroms or less as measured by Atomic Force Microscopy (AFM) over a 10 μm×10 μm area, of 20 Angstroms or less as measured by Atomic Force Microscopy (AFM) over a 10 μm×10 μm area, of 18 Angstroms or less as measured by Atomic Force Microscopy (AFM) over a 10 μm×10 μm area, of 16 Angstroms or less as measured by Atomic Force Microscopy (AFM) over a 10 μm×10 μm area, of 14 Angstroms or less as measured by Atomic Force Microscopy (AFM) over a 10 μm×10 μm area, of 12 Angstroms or less as measured by Atomic Force Microscopy (AFM) over a 10 μm×10 μm area, of 10 Angstroms or less as measured by Atomic Force Microscopy (AFM) over a 10 μm×10 μm area, of 9 Angstroms or less as measured by Atomic Force Microscopy (AFM) over a 10 μm×10 μm area, of 8 Angstroms or less as measured by Atomic Force Microscopy (AFM) over a 10 μm×10 μm area, of 7 Angstroms or less as measured by Atomic Force Microscopy (AFM) over a 10 μm×10 μm area, of 6 Angstroms or less as measured by Atomic Force Microscopy (AFM) over a 10 μm×10 μm area, of 5 Angstroms or less as measured by Atomic Force Microscopy (AFM) over a 10 μm×10 μm area, of 4 Angstroms or less as measured by Atomic Force Microscopy (AFM) over a 10 μm×10 μm area, of 3 Angstroms or less as measured by Atomic Force Microscopy (AFM) over a 10 μm×10 μm area, of 2 Angstroms or less as measured by Atomic Force Microscopy (AFM) over a 10 μm×10 μm area, of 1 Angstroms or less as measured by Atomic Force Microscopy (AFM) over a 10 μm×10 μm area, or of 0.5 Angstroms or less as measured by Atomic Force Microscopy (AFM) over a 10 μm×10 μm area.

In some embodiments, the polishing is sufficient to obtain a polished substrate having an average surface roughness, Sₐ, of 1 Angstrom to 10 Angstroms as measured by Atomic Force Microscopy (AFM) over a 10 μm×10 μm area, or any range or subrange between 1 Angstrom and 10 Angstroms. In some embodiments, the polishing is sufficient to obtain a polished substrate having an average surface roughness, Sₐ, of 1 Angstrom to 9 Angstroms, 1 Angstrom to 8 Angstroms, 1 Angstrom to 7 Angstroms, 1 Angstrom to 6 Angstroms, 1 Angstrom to 5 Angstroms, 1 Angstrom to 4 Angstroms, 1 Angstrom to 3 Angstroms, 1 Angstrom to 2 Angstroms, 2 Angstroms to 10 Angstroms, 3 Angstroms to 10 Angstroms, 4 Angstroms to 10 Angstroms, 5 Angstroms to 10 Angstroms, 6 Angstroms to 10 Angstroms, 7 Angstroms to 10 Angstroms, 8 Angstroms to 10 Angstroms, or 9 Angstroms to 10 Angstroms as measured by Atomic Force Microscopy (AFM) over a 10 μm×10 μm area.

In some embodiments, the polishing is sufficient to obtain a polished substrate having an average surface roughness, Sₐ, of 1 Angstrom to 50 Angstroms as measured by Atomic Force Microscopy (AFM) over a 10 μm×10 μm area, or any range or subrange between 1 Angstrom and 50 Angstroms. In some embodiments, the polishing is sufficient to obtain a polished substrate having an average surface roughness, Sₐ, of 1 Angstrom to 45 Angstroms, 1 Angstrom to 40 Angstroms, 1 Angstrom to 35 Angstroms, 1 Angstrom to 30 Angstroms, 1 Angstrom to 25 Angstroms, 1 Angstrom to 20 Angstroms, 1 Angstrom to 18 Angstroms, 1 Angstrom to 16 Angstroms, 1 Angstrom to 15 Angstroms, 1 Angstrom to 14 Angstroms, 1 Angstrom to 12 Angstroms, 1 Angstrom to 10 Angstroms, 1 Angstrom to 9 Angstroms, 1 Angstrom to 8 Angstroms, 1 Angstrom to 7 Angstroms, 1 Angstrom to 6 Angstroms, 1 Angstrom to 5 Angstroms, 1 Angstrom to 4 Angstroms, 1 Angstrom to 3 Angstroms, 1 Angstrom to 2 Angstroms, 2 Angstroms to 10 Angstroms, 3 Angstroms to 10 Angstroms, 4 Angstroms to 10 Angstroms, 5 Angstroms to 10 Angstroms, 6 Angstroms to 10 Angstroms, 7 Angstroms to 10 Angstroms, 8 Angstroms to 10 Angstroms, or 9 Angstroms to 10 Angstroms. In some embodiments, the average surface roughness, Sₐ, of the polycrystalline substrate is 5 Angstroms to 50 Angstroms, 10 Angstroms to 50 Angstroms, 15 Angstroms to 50 Angstroms, 20 Angstroms to 50 Angstroms, 25 Angstroms to 50 Angstroms, 30 Angstroms to 50 Angstroms, 35 Angstroms to 50 Angstroms, 40 Angstroms to 50 Angstroms, or 45 Angstroms to 50 Angstroms. In some embodiments, the average surface roughness refers to the root mean square (RMS) roughness.

Any one or more of the embodiments disclosed herein shall be understood to be combinable without departing from the scope or spirit of the disclosure.

### EXAMPLE

Various sample compositions were prepared and the polishing performance of each was measured. Table 1 provides the formulation details for each of the samples.

TABLE 1

| | Diamond | Alumina | Polyamide and |
|---|---|---|---|
| | Particles | Particles | Polyether Mixture |
| Sample | (wt. %) | (wt. %) | (wt. %) |
| A | 3 | 1 | 0 |
| B | 3 | 1 | 2 |
| C | 3 | 1 | 4 |
| D | 0.75 | 6 | 0 |
| E | 0.75 | 6 | 2 |
| F | 0.75 | 6 | 4 |

In each of Sample A, B, and C, the average particle size of the diamond particles was 0.25 μm and the average particle size of the alumina particles was 0.75 μm. In each of Sample D, E, and F, the average particle size of the diamond particles was 0.25 μm and the average particle size of the alumina particles was 3 μm. Table 2 provides the diamond size and alumina size for each of the samples.

Table 2 provides the material removal rate (MRR) and surface roughness values for each of the samples.

TABLE 2

| Slurry | MRR (microns/hr) | Rₐ (nm) | R_{q} (nm) |
|---|---|---|---|
| A | 2.7 | 0.9 | 1.2 |
| B | 4.7 | 0.7 | 0.9 |
| C | 8.3 | 0.9 | 1.1 |
| D | 9.8 | 1.3 | 1.6 |
| E | 11.5 | 1 | 1.3 |
| F | 13.2 | 1.5 | 1.9 |

### Aspects

Various Aspects are described below. It is to be understood that any one or more of the features recited in the following Aspect(s) can be combined with any one or more other Aspect(s).
Aspect 1. A composition comprising:
   a water soluble polymer;
   a first plurality of particles; and
   a second plurality of particles,
      wherein, when the composition is contacted with a polycrystalline substrate and when the polycrystalline substrate is polished by the composition, the composition comprises a sufficient amount of the water soluble polymer, the first plurality of particles, and the second plurality of particles to result in:
         A) a material removal rate of at least 0.5 μm; and/or
         B) an average surface roughness, Sₐ, of 50 Angstroms or less,
         wherein the average surface roughness is measured by Atomic Force Microscopy (AFM) over a 10 μm×10 μm area.
Aspect 2. The composition according to Aspect 1, wherein the composition comprises:
   0.01% to 5% by weight of the water soluble polymer based on a total weight of the composition.
Aspect 3. The composition according to any one of Aspects 1-2, wherein the composition comprises:
   0.01% to 5% by weight of the first plurality of particles based on a total weight of the composition; and
   0.01% to 5% by weight of the second plurality of particles based on the total weight of the composition.
Aspect 4. The composition according to any one of Aspects 1-3, wherein:
   the first plurality of particles has an average particle size of 10 nm to 5000 nm; and
   the second plurality of particles has an average particle size of 10 nm to 5000 nm.
Aspect 5. The composition according to any one of Aspects 1-4, wherein:
   the first plurality of particles has an isoelectric point of greater than 7; and
   the second plurality of particles has an isoelectric point of 7 or less.
Aspect 6. The composition according to any one of Aspects 1-5, wherein the first plurality of particles is dimensioned so as to have an aspect ratio of 2:1 to 10:1.
Aspect 7. The composition according to any one of Aspects 1-6, wherein the material removal rate of the composition is 0.5 μm per hour to 25 μm per hour.
Aspect 8. The composition according to any one of Aspects 1-7, wherein the average surface roughness, Sₐ, of the polycrystalline substrate is 1 Angstrom to 50 Angstroms. Aspect 9. The composition according to any one of Aspects 1-8, wherein the water soluble polymer comprises at least one of a clay, a polyolefin, a polyamide, or any combination thereof.
Aspect 10. The composition according to any one of Aspects 1-9, wherein the first plurality of particles comprises at least one of an alumina, a mixed phase alumina, or any combination thereof.
Aspect 11. The composition according to any one of Aspects 1-10, wherein the second plurality of particles comprises a diamond.
Aspect 12. A composition comprising:
   a first plurality of particles; and
   a second plurality of particles,
      wherein, when the composition is contacted with a polycrystalline substrate and when the polycrystalline substrate is polished by the composition, the composition comprises a sufficient amount of the first plurality of particles and the second plurality of particles to result in:
         A) a material removal rate of at least 0.5 μm; and/or
         B) an average surface roughness, Sₐ, of 50 Angstroms or less,
         wherein the average surface roughness is measured by Atomic Force Microscopy (AFM) over a 10 μm×10 μm area.
Aspect 13. The composition according to Aspect 12, wherein the composition comprises:
   0.01% to 5% by weight of the first plurality of particles based on a total weight of the composition; and
   0.01% to 5% by weight of the second plurality of particles based on the total weight of the composition.
Aspect 14. The composition according to any one of Aspects 12-13, wherein:
   the first plurality of particles has an average particle size of 10 nm to 5000 nm; and
   the second plurality of particles has an average particle size of 10 nm to 5000 nm.
Aspect 15. The composition according to any one of Aspects 12-14, wherein: the first plurality of particles has an isoelectric point of greater than 7; and the second plurality of particles has an isoelectric point of 7 or less.
Aspect 16. The composition according to any one of Aspects 12-15, wherein the first plurality of particles is dimensioned so as to have an aspect ratio of 2:1 to 10:1.
Aspect 17. The composition according to any one of Aspects 12-16, wherein the material removal rate of the composition is 0.5 μm per hour to 25 μm per hour.
Aspect 18. The composition according to any one of Aspects 12-17, wherein the average surface roughness, Sₐ, of the polycrystalline substrate is 1 Angstrom to 50 Angstroms.
Aspect 19. A method comprising:
   obtaining a polycrystalline substrate;
   obtaining a composition,
      wherein the composition comprises:
         a water soluble polymer;
         a first plurality of particles; and
         a second plurality of particles; and
   polishing the polycrystalline substrate, while the composition is located between the polycrystalline substrate and a polishing pad, to obtain a polished substrate.
Aspect 20. The method according to Aspect 19, wherein:
   the polishing comprises removing material at a rate of 0.5 μm per hour to 25 μm per hour; and/or
   the polished substrate has an average surface roughness, Sₐ, of 50 Angstroms or less as measured by Atomic Force Microscopy (AFM) over a 10 μm×10 μm area.

What is claimed is:

1. A composition comprising:
a water soluble polymer;
a first plurality of particles; and
a second plurality of particles,
wherein, when the composition is contacted with a polycrystalline substrate and when the polycrystalline substrate is polished by the composition, the composition comprises a sufficient amount of the water soluble polymer, the first plurality of particles, and the second plurality of particles to result in:
A) a material removal rate of at least 0.5 μm; and/or
B) an average surface roughness, Sₐ, of 50 Angstroms or less,
wherein the average surface roughness is measured by Atomic Force Microscopy (AFM) over a 10 μm×10 μm area.

2. The composition of claim 1, wherein the composition comprises:
0.01% to 5% by weight of the water soluble polymer based on a total weight of the composition.

3. The composition of claim 1, wherein the composition comprises:
0.01% to 5% by weight of the first plurality of particles based on a total weight of the composition; and
0.01% to 5% by weight of the second plurality of particles based on the total weight of the composition.

4. The composition of claim 1, wherein:
the first plurality of particles has an average particle size of 10 nm to 5000 nm; and
the second plurality of particles has an average particle size of 10 nm to 5000 nm.

5. The composition of claim 1, wherein:
the first plurality of particles has an isoelectric point of greater than 7; and
the second plurality of particles has an isoelectric point of 7 or less.

6. The composition of claim 1, wherein the first plurality of particles is dimensioned so as to have an aspect ratio of 2:1 to 10:1.

7. The composition of claim 1, wherein the material removal rate of the composition is 0.5 μm per hour to 25 μm per hour.

8. The composition of claim 1, wherein the average surface roughness, Sₐ, of the polycrystalline substrate is 1 Angstrom to 50 Angstroms.

9. The composition of claim 1, wherein the water soluble polymer comprises at least one of a clay, a polyolefin, a polyamide, or any combination thereof.

10. The composition of claim 1, wherein the first plurality of particles comprises at least one of an alumina, a mixed phase alumina, or any combination thereof.

11. The composition of claim 1, wherein the second plurality of particles comprises a diamond.

12. A composition comprising:
a first plurality of particles; and
a second plurality of particles,
wherein, when the composition is contacted with a polycrystalline substrate and when the polycrystalline substrate is polished by the composition, the composition comprises a sufficient amount of the first plurality of particles and the second plurality of particles to result in:
A) a material removal rate of at least 0.5 μm; and/or
B) an average surface roughness, Sₐ, of 50 Angstroms or less,
wherein the average surface roughness is measured by Atomic Force Microscopy (AFM) over a 10 μm×10 μm area.

13. The composition of claim 12, wherein the composition comprises:
0.01% to 5% by weight of the first plurality of particles based on a total weight of the composition; and
0.01% to 5% by weight of the second plurality of particles based on the total weight of the composition.

14. The composition of claim 12, wherein:
the first plurality of particles has an average particle size of 10 nm to 5000 nm; and
the second plurality of particles has an average particle size of 10 nm to 5000 nm.

15. The composition of claim 12, wherein:
the first plurality of particles has an isoelectric point of greater than 7; and
the second plurality of particles has an isoelectric point of 7 or less.

16. The composition of claim 12, wherein the first plurality of particles is dimensioned so as to have an aspect ratio of 2:1 to 10:1.

17. The composition of claim 12, wherein the material removal rate of the composition is 0.5 μm per hour to 25 μm per hour.

18. The composition of claim 12, wherein the average surface roughness, Sₐ, of the polycrystalline substrate is 1 Angstrom to 50 Angstroms.

19. A method comprising:
obtaining a polycrystalline substrate;
obtaining a composition,
wherein the composition comprises:
a water soluble polymer;
a first plurality of particles; and
a second plurality of particles; and
polishing the polycrystalline substrate, while the composition is located between the polycrystalline substrate and a polishing pad, to obtain a polished substrate.

20. The method of claim 19, wherein:
the polishing comprises removing material at a rate of 0.5 μm per hour to 25 μm per hour; and/or
the polished substrate has an average surface roughness, Sₐ, of 50 Angstroms or less as measured by Atomic Force Microscopy (AFM) over a 10 μm×10 μm area.
